(19) United States
(12) Patent Application Publication
(10) Pub. No.: US 2007/0270726 A1
(43) Pub. Date: Nov. 22, 2007

(54) Vibrating device for fitness equipment

(76) Inventor: Hsien-Nan Chou, Taichung City (TW)

Correspondence Address: EGBERT LAW OFFICES, 412 MAIN STREET, 7TH FLOOR, HOUSTON, TX, 77002, US

(21) Appl. No.: 11/436,944

(22) Filed: May 19, 2006

(51) Int. Cl. A61H 1/00

(52) U.S. Cl. 601/70; 601/69; 601/49

(57) ABSTRACT

The vibrating device for fitness equipment includes a control unit mounted onto a preset location of the fitness equipment; and a vibrating body assembled into a space within the fitness equipment. The vibrating body allows signal transmission with the control unit. The vibrating body has a vibrating source, vibrating seat and massager, the vibrating seat with an exposed part being mounted over the vibrating source. The massager is mounted onto the vibrating seat for human contact. When the control unit transmits an active signal to the vibrating body, the vibrating source is activated, and the vibrating seat is driven synchronously to generate vibration for the desired massage effect.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a vibrating device for fitness equipment, and more particularly to an adjustable vibrating device which can be mounted onto any location of indoor and outdoor fitness equipment for improved functionality and added value.

### BACKGROUND OF THE INVENTION

Due to limitations of athletic exercises and the ambient environment, there is a growing demand to improve the physical quality of fitness equipment. Some fitness equipment can be operated individually under any weather conditions, at anytime, anywhere, thus helping to meet the demands for physical fitness in any environment.

Indoor and outdoor fitness equipment is currently available. For example, indoor fitness equipment for individual applications generally includes the treadmill, stepper, exercise bike, ski machine, elliptical trainer and barbell sets, which have now become optimal tools for personal physical exercises.

In spite of the benefits of existing fitness equipment, such as the ability to improve health through individual physical exercise, the aching pain and stiffness of muscles can only be alleviated by means of massage in order to facilitate blood circulation and metabolism. Traditional massage is manually performed and is classified as pressing, tapping and rubbing.

Today, there are a variety of massage devices for people, and the massage devices are also classified as pressing, tapping, rubbing and vibrating according to the category. However, the main purpose of existing fitness equipment is focused on health building and not on massage. Also, alleviating muscle pain requires massage devices in a bigger space, sacrificing multiple functions in a device and compact product design.

Thus, to overcome the aforementioned problems of the prior art, it would be an advancement in the art to provide an improved structure that can significantly improve the efficacy of fitness equipment.

To this end, the inventor has provided the present invention of practicability after deliberate design and evaluation based on years of experience in the production, development and design of related products.

### BRIEF SUMMARY OF THE INVENTION

The present invention is a vibrating device for fitness equipment 01. The fitness equipment 01 has a space 10 provided for easy assembly of the vibrating device 20. The fitness equipment 01 provides a vibrating massage and alleviates muscle pain in addition to body building. These functions will be very useful to considerably improve the functionality and added value of the fitness equipment for a higher level of competitive power and practicability.

The vibrating device for fitness equipment of the present invention allows a control unit 30 to activate or disable the vibrating device 20. An adjuster 34 adjusts the vibrating frequency and amplitude of the vibrating source 21, thereby satisfying diversified demands of users with adjustable massage functions.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective of the preferred embodiment of the present invention.

FIG. 2 shows an exploded perspective view of the vibrating device of the present invention.

FIG. 3 shows an enlarged perspective view of the vibrating device of the present invention.

FIG. 4 shows a perspective and partial schematic view of the vibrating device installed on the treadle.

FIG. 5 shows another perspective and partial schematic view of the vibrating device installed on the seat.

FIG. 6 shows a perspective view of the vibrating device installed on each part of the treadmill.

FIG. 7 shows another perspective and partial schematic view of the vibrating device installed on the treadmill handle.

FIG. 8 shows a partial perspective view of the vibrating device installed on the treadmill frame.

FIG. 9 shows a schematic view of the vibrating device installed on the treadmill base.

FIG. 10 shows a perspective view of the vibrating device installed on the adjustable flat bench.

FIG. 11 shows a perspective view of the vibrating device installed on the stepper.

FIG. 12 shows a perspective view of the vibrating device installed on the elliptical trainer.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

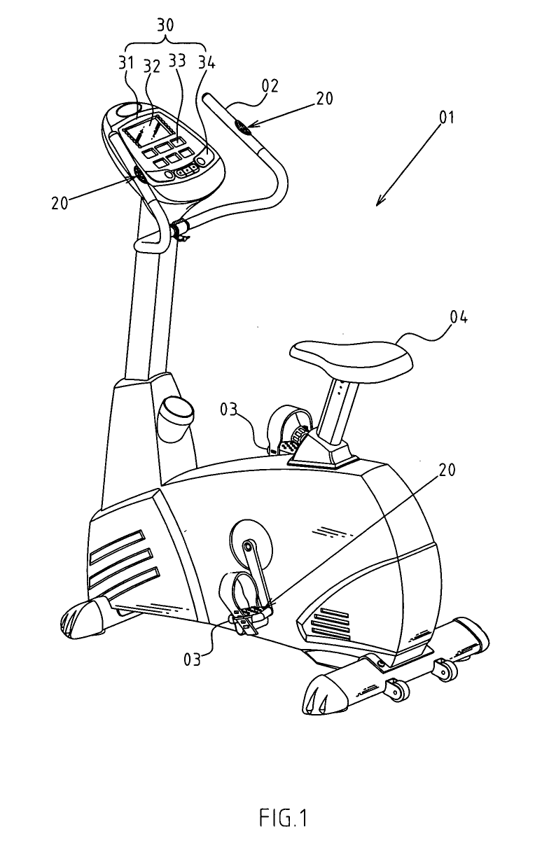

FIGS. 1, 2, and 3 depict a preferred embodiment of a vibrating device for fitness equipment of the present invention, provided only for explanatory purposes of the claims. The fitness equipment 01 of the present invention includes a space 10 within the fitness equipment 01, wherein the vibrating device 20 and a control unit 30 of the fitness equipment 01 are mounted. The space 10 of the present invention is fixed onto a handle 02 of fitness equipment 01.

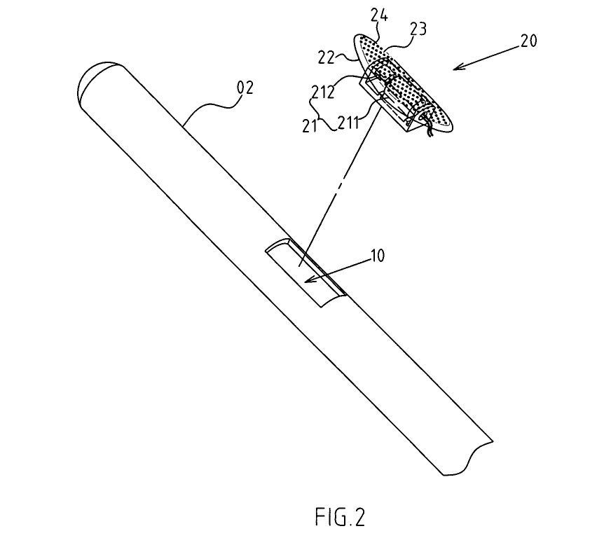

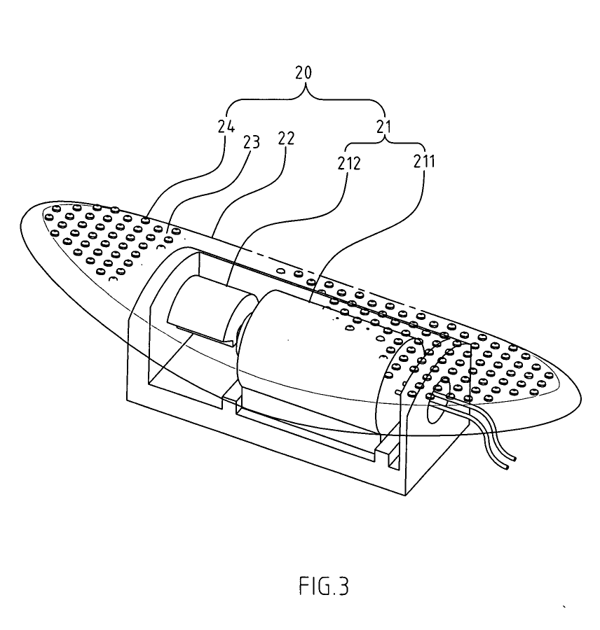

Referring to FIG. 3, a vibrating device 20 comprises a vibrating source 21, a vibrating seat 22 and a massager 23. The vibrating source 21 is mounted into the aforementioned space 10 (as shown in FIG. 2). The vibrating source 21 comprises a vibrating motor 211 and an eccentric member 212, of which the eccentric member 212 may be a cam mounted onto the drive axle of vibrating motor 211. It allows for eccentric rotation and then leads to vibration. A vibrating seat 22 with an exposed part is mounted over vibrating source 21. A massager 23 with many convex massage particles 24 is mounted onto vibrating seat 22 for human contact.

Referring to FIG. 1, the control unit 30 is mounted into fitness equipment 01, and allows signal transmission with vibrating device 20. The control unit 30 comprises a control panel 31, a display 32 and a small keypad 33, the display 32 and keypad 33 being mounted onto the control panel 31. The keypad 33 is used to activate and disable the vibrating device 20. The control unit 30 also comprises an adjuster 34, which adjusts and controls the vibrating frequency and amplitude of the vibrating source 21.

Based upon the above-mentioned structural members, the control unit 30 is used to transmit an active signal to the vibrating device 20, while the vibrating seat 22 is powered by vibrating source 21 to vibrate synchronously, leading to the desired vibrating massage.

Based upon above-mentioned structural design, the present invention functions as described herein.

Referring to FIGS. 1, 2, and 3, when one key of keypad 33 is pressed, the control unit 30 will transmit an active signal to the vibrating device 20, which actuates a vibrating source 21 in a controlled way. The vibrating seat 22 is powered by vibrating source 21 for synchronous vibration. The adjuster can adjust and control the vibrating frequency and amplitude of the vibrating source 21. To stop the massage, the keypad 33 is pressed again, the control unit 30 then transmitting a stop signal to the vibrating device 20 to stop vibration.

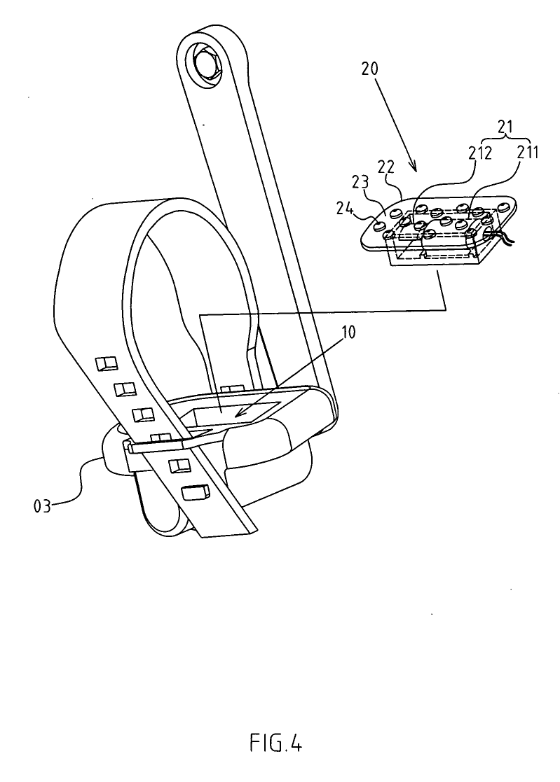

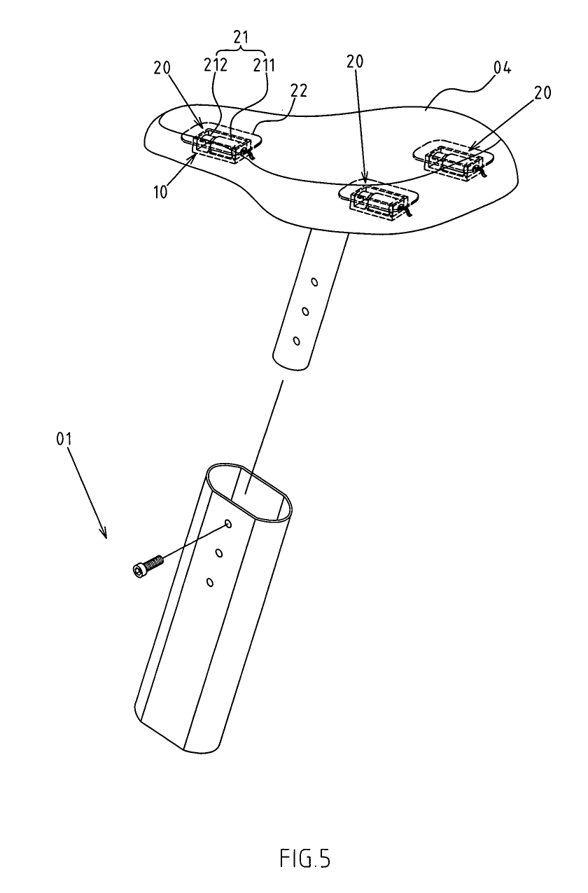

FIGS. 1 and 4 depict another preferred embodiment of the present invention. The space 10 is mounted into a treadle 03 of the fitness equipment 01. The vibrating device 20 is placed into the space 10. Referring to FIGS. 1 and 5, the vibrating device 20 is mounted onto a seat pad 04 of the fitness equipment 01. Three spaces 10 are horizontally arranged under seat pad 04, and the vibrating devices 20 are separately mounted into the spaces 10, such that control unit 30 can activate and disable the vibrating massage.

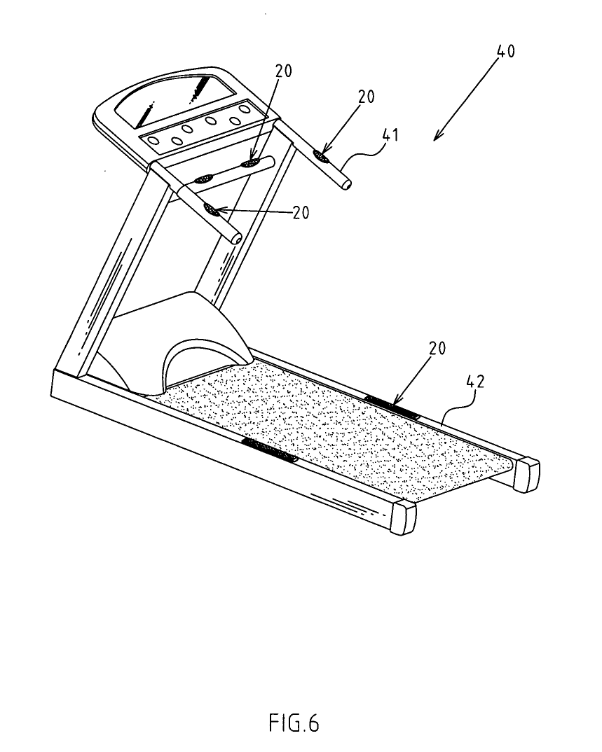

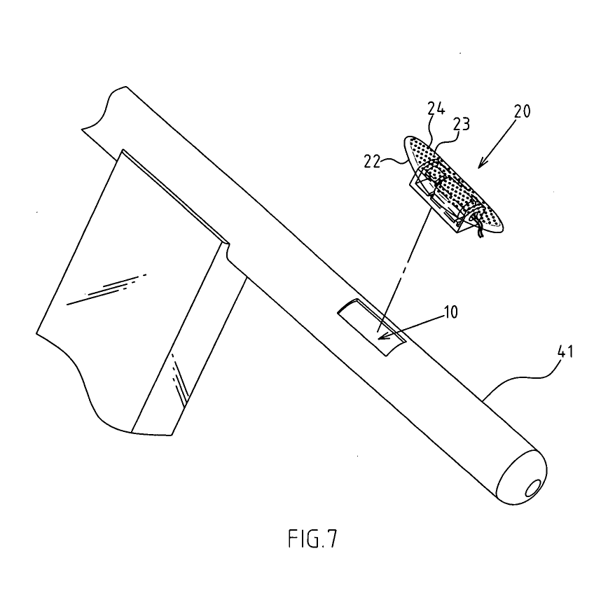

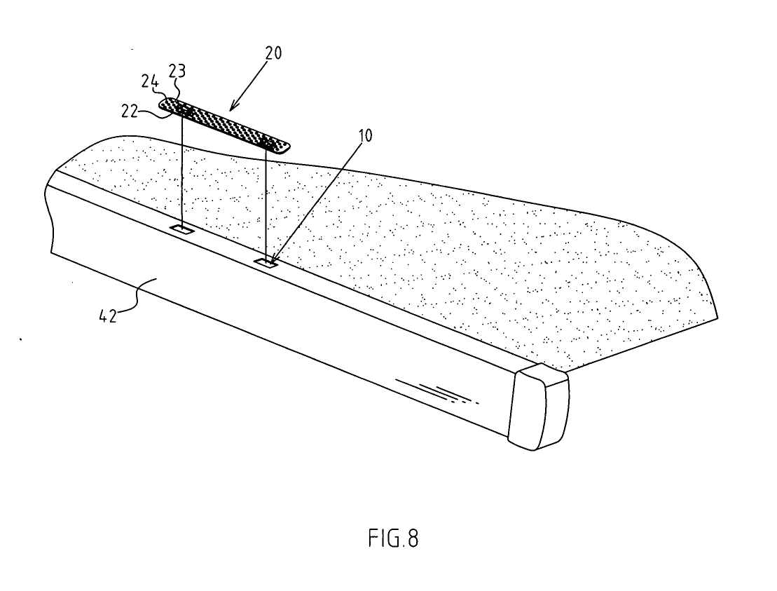

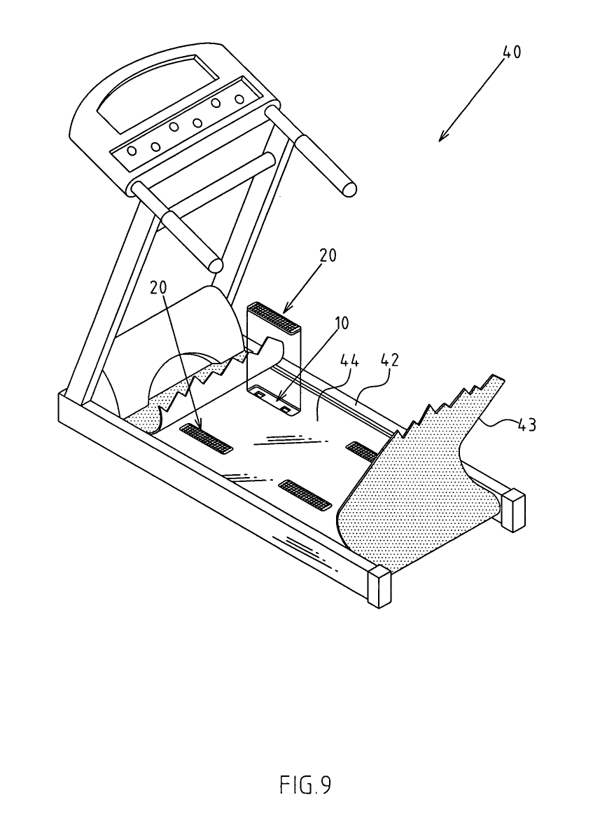

FIGS. 6-8 depict another preferred embodiment of the present invention. Some spaces 10 are separately mounted onto handle 41 and support frame 42 of treadmill 40. The vibrating seat 22 at the handle 41 has a cambered surface for manual grip (as shown in FIG. 7). The upper side of vibrating seat 22 runs parallel with an upper flange of the support frame 42 (as shown in FIG. 8), thus enabling a foot massage. The massager 23 (as shown in FIG. 7) may be made of plastic materials, and covered onto the vibrating seat 22. On the upper side of the massager 23, a few convex massage particles 24 are provided to improve the massage effect. Referring to FIG. 9, the vibrating device 20 is mounted onto foundation 44 under treadmill belt 43 of treadmill 40. Some spaces 10 are separately arranged around foundation 44 to accommodate the vibrating device 20. In case a user steps on the treadmill belt 43, the vibration of vibrating device 20 can be transmitted via the treadmill belt 43 to the user for the vibrating massage.

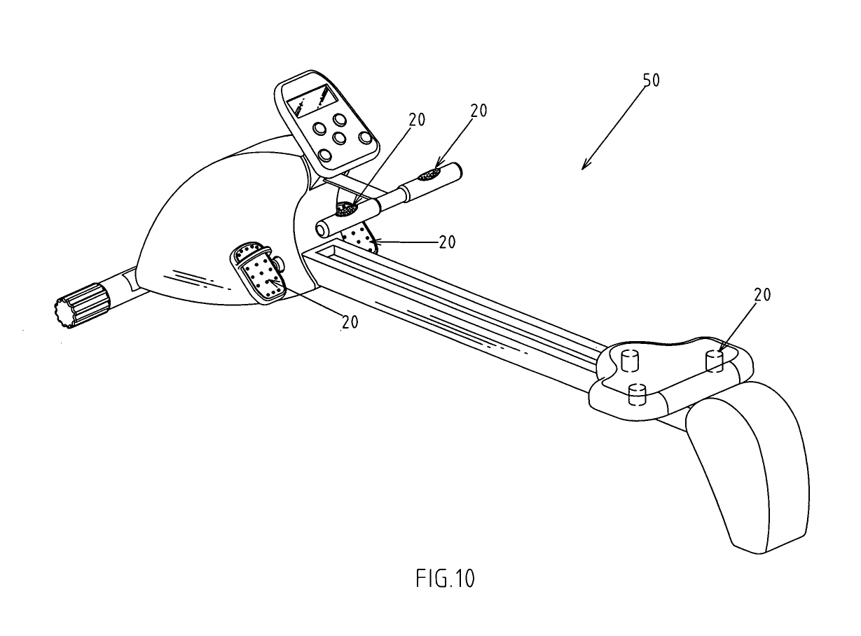

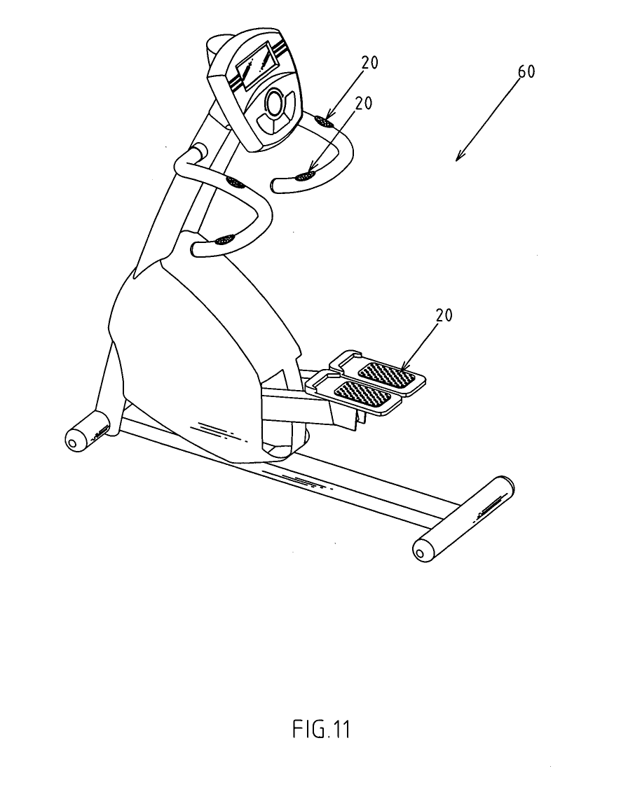

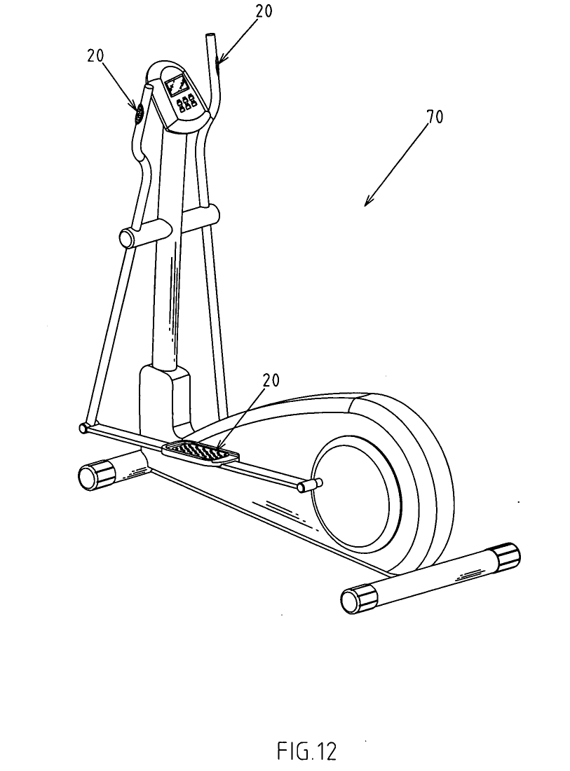

FIGS. 10-12 depict another preferred embodiment of the present invention. A vibrating device 20 is separately applied to adjustable flat bench 50, stepper 60 and elliptical trainer 70. Different forms of vibrating devices 20 can be used according to the mounting locations. The vibrating device 20 can be horizontally or straightly arranged where necessary.

The vibrating source 21 of vibrating device 20 can be implemented through another vibrating structure. For example, supersonic vibrating enables it to generate high-speed vibration waves via supersonic mechanical vibration. Alternatively, magnetic valve vibrating enables it to generate vibration waves for the same vibration effect via magnetic force. Thus, these vibrating modes are covered by the claims.

Additionally, a vibrating device 20 can be mounted into space 10 via the following:

1. Locking means, wherein a hook and locking groove are located by a liner lock;

2. Screwing means, wherein a bolt is fastened into bolt hole; and

3. Adhering means, wherein adhesive tape or double-sided adhesive is applied to the mounting location.

I claim:

1. A vibrating device for fitness equipment, comprising:
a control unit, being mounted onto a preset location of said fitness equipment;
a vibrating body installed within a space within said fitness equipment, said vibrating body providing signal transmission to said control unit, said vibrating body being comprised of a vibrating source, a vibrating seat and a massager, said vibrating seat having an exposed part mounted over said vibrating source, said massager being mounted onto said vibrating seat for human contact.

2. The device defined in claim 1, wherein said control unit is comprised of a control panel, display and keypad, said control panel being mounted onto a preset location on said fitness equipment, said display and said keypad being installed onto said control panel, one key of said keypad being used to activate and disable said vibrating body.

3. The device defined in claim 2, wherein said keypad is comprised of an adjuster used to control vibrating frequency and amplitude of said vibrating source.

4. The device defined in claim 1, wherein said vibrating source is comprised of a motor and an eccentric member, said eccentric member being mounted onto a drive axle of said motor enabling eccentric rotation for a desired vibration effect.

5. The device defined in claim 4, wherein said eccentric member is comprised of a cam.

6. The device defined in claim 1, wherein said vibrating source is a supersonic vibrating source, yielding high-speed vibrating waves via supersonic mechanical vibration.

7. The device defined in claim 1, wherein said vibrating source is a magnetic valve, yielding a vibrating wave via a magnetic force.

8. The device defined in claim 1, wherein said massager is comprised of plastic materials, being covered onto said vibrating seat, said massager having a plurality of convex massage particles on an upper side thereof.

9. The device defined in claim 1, wherein said space is mounted into the fitness equipment at any location in the group consisting of: a handle, seat pad, treadle, foundation, support frame, and any combination thereof.

10. The device defined in claim 1, wherein said vibrating body is mounted into said space by a locking means, a screwing means or an adhering means.
